(19) United States
(12) Patent Application Publication
(10) Pub. No.: US 2007/0114750 A1
(43) Pub. Date: May 24, 2007

(54) WHEELCHAIR PROPULSION AND EXERCISE ATTACHMENT

(76) Inventors: Rollin C. Dix, Chicago, IL (US); Rahuljit Pal, New Delhi (IN)

Correspondence Address: PATZIK, FRANK & SAMOTNY LTD., 150 SOUTH WACKER DRIVE, SUITE 1500, CHICAGO, IL, 60606, US

(21) Appl. No.: 11/532,791

(22) Filed: Sep. 18, 2006

Related U.S. Application Data
(60) Provisional application No. 60/722,676, filed on Sep. 30, 2005.

(51) Int. Cl. B62M 1/14

(52) U.S. Cl. 280/250.1

(57) ABSTRACT

The “Pedalong” is a propulsion and exercise device attaching to a conventional wheelchair having: a drive support system attaching to the wheelchair frame and supporting a drive main frame; a propulsion system including an input unit operated by the user proximate the front end; and further including at least one drive wheel operably interposed between the rear set of wheelchair wheels. a power transmission assembly interposed between the input unit and the drive wheel to transmit power from said input unit to the drive wheel when engaged by the user to propel the device. The propulsion system can be: belt driven; chain driven; shaft driven; fluid power driven; or electrically driven. The input unit is mounted at a forward end of the main frame, so as to be adjustable in length.

This application claims priority to United States provisional patent application Ser. No. 60/722,676, filed Sep. 30, 2005.

### BACKGROUND OF THE INVENTION

The invention known as the “Pedalong” is a foot-powered exercise and propulsion wheelchair-type vehicle and, in particular, a foot-powered attachment for propulsion by and therapeutic exercise for the seated user of a wheelchair.

### THE PRIOR ART

Wheelchair mobility improvements and exercising devices have been developed by numerous inventors. Berkheimer (U.S. Pat. No. 5,273,304) discloses a leg-powered, lean-steerable attachment for a wheelchair. This device attaches to the underside of the wheelchair with a pole extending forward and carrying a bearing for a vertical axis about which steering of a pedaled front wheel occurs. This new front wheel lifts the wheelchair's two front wheels so the combination behaves like a tricycle.

Long et al (U.S. Pat. No. 6,910,701) discloses a wheelchair propulsion using hand cranks driving sprockets which (through chain connection) drive the large rear wheels of the chair. The cranks reciprocate, rather than rotate through 360 degrees to ease the user's task.

McKelvey (U.S. Pat. No. 5,207,286) discloses a bicycle-like front end for a wheelchair with pumping rather than rotating pedals. Merlan (U.S. Pat. No. 3,485,510) powers the wheelchair's forward motion with hand-cranked pedals above a chain-driven front wheel. This assembly is on a pivotable support for steering.

Adams (U.S. Pat. No. 6,409,195) discloses a “sport-type” wheelchair which is tricycle-form with the pedals driving the rear wheels through a chain and sprockets.

Benz (U.S. Pat. No. 3,912,032) discloses a gasoline engine powered front end for a wheelchair. This front-end device attaches and lifts the front two wheels of the wheelchair converting it into a tricycle.

Van Vooren (U.S. Pat. No. 5,066,032) merges a hand-driven bicycle at the front end of a wheelchair and lifts the forward wheels of the wheelchair with attachment of the bicycle.

Young (U.S. Pat. No. 4,471,972) discloses a hand-driven front end to the wheelchair which lifts the front wheels of the wheelchair.

Durham et al (U.S. Pat. No. 4,572,501) disclose an exercise attachment which fits under and lifts the wheelchair's front wheels from the ground. The device is claimed to also have a propulsion mode. The attachment has four wheels which are in front of the wheelchair when attached.

Moore (U.S. Pat. No. 4,824,132) discloses an arm exercise device connecting to the front of the wheelchair. Moore's device also has a propulsion mode in which a forward wheel is lowered to the ground raising the wheelchair's front two wheels.

In 2002, Sir Clive Sinclair introduced an electrically powered “fifth wheel” which is placed centrally and rearward of the wheelchair's large rear wheels and pivoted from the frame downward so that friction between this wheel and the ground provides sufficient traction to assist in driving the wheelchair forward. The unit is intended to aid attendants in moving persons in wheelchairs up ramps or inclines.

A published Japanese patent application (Publication No. 2003-339779; published Dec. 2, 2003) owned by Honda Seiki K K, discloses a pedal drive type wheelchair. In the Honda device, the front wheels function as drive wheels and the rear wheels function as steering wheels. The seat is movable longitudinally to adjust for the size of the user as well as rotationally, to ease entry and exit from the device. Steering is provided by way of a steering shaft connected to gearing serving to turn the rear wheels. Finally, Honda Rikio describes a foot-operated wheelchair driving mechanism in Japan Patent Abstract 2004-065887 published on 3 Apr. of 2004. His device incorporates a driving pedal system in front and a driving fifth wheel in the rear both mounted on a connecting gear case which pivots at a shaft fixed to the frame of the wheelchair and penetrating across at the front of the gear case. The rear part of the gear case is pushed down by a spring fixed to the frame of the wheelchair rearward of the pivot, and thus supplying grounding pressure. See, www.hondaseiki.co.jp/kaihatuchu.htm.

The present invention differs from and provides improvements over this Honda design in its elimination of the forward pivot and hold-down spring and in its connection of the rear wheel axle rigidly to the wheelchair frame. This rigid connection eliminates the tendency of the hold-down spring to pitch the wheelchair forward. Also, pivoting about the rear wheel axle permits the raising and lowering, and telescoping, of the system for greatly improved user comfort and adjustability to user size.

### OBJECTS AND SUMMARY OF THE INVENTION

The invention (“Pedalong”) disclosed herein is for both exercise and propulsion of wheelchair-bound individuals. These decreased mobility individuals include the very elderly, recovering accident, stroke, and heart attack victims, and chronic disease victims like cerebral palsy, MS, obesity and diabetes.

A principal innovation is locating a “fifth wheel” centrally between the rear wheels and on its own fixed horizontal axle directly below the rear wheel axis. This fifth wheel's lower edge is adjusted relative to the lower edge of the two rear wheels so that most of the user's weight teeters between the fifth wheel and one or the other of the rear wheels—much like the rear wheel on a child's bike with training wheels attached. Of course, part of the user's weight is carried on the two front wheels. On this fifth wheel axle, a projecting-forward telescoping tube is mounted to support the pedals. From the pedals power is transmitted to the fifth wheel by a belt, shaft or chain drive. The telescoping tubes permit the length and an adjustable front support permits the height of the pedals to be adjusted by the therapist or the user. The telescoping tubes also enable retraction of the pedal mechanism under the chair when not needed.

Steering can be accomplished by turning one of the front wheels with a handle mounted at the armrest level, or by the user's leaning in the direction of the desired turn and continuing to pedal the fifth wheel while retarding the rear wheel now on the ground. The front wheels are on castors and follow the steering movement for either method of steering by the occupant of the wheelchair. It is also possible for the therapist or attendant to completely control direction of movement by simply pushing the wheelchair in the desired direction.

### ALTERNATIVE EMBODIMENTS OF THE INVENTION

In the first embodiment described herein, the pedal-supporting mast's length and the height of the front support are fixed. To ease user access, the second embodiment provides a means for adjusting the height at the front support, including lowering the pedal end to the ground and telescoping the front end under the wheelchair. These capabilities also provide adjustability for size of user. This second embodiment's adjustments are operated by a therapist from the front of the wheelchair. In the third embodiment, the extension and retraction adjustment is operated by the user with a side handle.

In the fourth embodiment an electrical motor and controller assists the pedaled drive of the second embodiment. In a fifth embodiment motors are provided for electrically lifting and/or telescoping the fourth embodiment's adjustment for user size and for ease of access for the user. In the sixth embodiment, the belt drive is replaced by a telescoping shaft-drive system.

Any of these embodiments can be supplied in small, medium and large main frame lengths to accommodate different users, and with other combinations of the features described. A variable width front pulley and a spring loaded, variable width rear pulley may be used to adjust for user strength, such as by providing lower gear ratio for harder pedaling or a higher gear ratio for easier pedaling. Also, a brake may be added to increase the exercise level. The provided means for changing the pedal arm length allows adjusting for user strength and/or for user range-of-motion. To motivate the user and assist the therapist, an odometer may be mounted on the front end of the device.

The Pedalong device comprises: a propulsion and exercise device attaching to a conventional wheelchair having a frame with at least two structural rails, pivoting front wheels, a rear set of laterally spaced wheels, and a surface for supporting the user. The device comprises: a drive support system attaching to the wheelchair frame and supporting a drive main frame; and, a propulsion system attached to the drive main frame and including an input unit operated by the user proximate the front end of the drive main frame. The propulsion system further includes at least one drive wheel operably interposed between the rear set of wheelchair wheels and has a rotational axis positioned parallel to and below the wheelchair's rear wheel axis such that the drive wheel(s) supports a portion of the user's weight. The propulsion system further includes a power transmission assembly interposed between the input unit and the drive wheel to transmit power from the input unit to the drive wheel when engaged by the user to propel the device.

The propulsion system can be belt driven; chain driven; shaft driven; fluid power driven; or electrically driven. The input unit is mounted at a forward end of the main frame, so as to be adjustable in length. Power can be transmitted to the drive wheel by: a hydraulic system; or an electrical system. The input unit comprises: a front power transfer link rotatably mounted on a shaft; and, at least one pedal operably mounted on said shaft to permit the user's rotation of the power transfer link.

The power transmission assembly is operably engaged with the power transfer link at one end and the drive wheel at the opposite end and wherein the drive wheel is fixedly mounted on a common shaft with drive wheel linkage. The power transfer link can be: a pulley-belt-pulley assembly; a gear-belt-gear assembly; a hydraulic pump, tubing operably connected to the pump, and, a hydraulic motor operably associated with the tubing; or, an electrical generator, wiring operably connected to the generator; and, an electric motor operably associated with the wiring.

The drive main frame is supported by the drive support system such that the drive main frame can rotate about an axis parallel to the axis of the drive wheel to provide height adjustability of the input unit and facilitate access to the user support surface by lowering. The main frame length is adjustable for user size and to further facilitate access to the user support surface. The drive main frame length adjustability is provided by telescoping tubes or other prismatic structure, and the transmission assembly automatically compensates for the length change through adjustment means. The adjustment means for mechanical systems comprises idler spockets, idler pulleys or splines. The height and/or length adjustments may be electrically driven.

Electrical power can be provided to the propulsion system to at least assist in driving the wheelchair. An odometer for recording the distance traveled can be provided. A brake may be provided for slowing, stopping or parking the wheelchair, as well as a “deadman switch” that releases the propulsion system to allow motion only when activated by the user. A method for weighing the wheelchair occupant using a conventional scale can also be provided. In addition a dynamometer may be included integrally or externally in order to measure the strength of the patient or for other purposes.

A method for converting a conventional wheelchair having a frame with at least two structural rails, pivoting front wheels, a rear set of laterally spaced wheels and a surface for supporting the use, to a propulsion and exercise device is also provided. The method comprises: operably attaching a drive support system to the frame and supporting a drive main frame; operably attaching a propulsion system attached to the drive main frame and including an input unit operated by the user proximate the front end of the drive main frame; operably interposing at least one drive wheel between the rear set of wheelchair wheels with a rotational axis parallel to and below the wheelchair rear wheel axis; and operably including a power transmission assembly interposed between the input unit and the drive wheel to transmit torque when engaged by the user to propel the device.

The invention further comprises a combination wheelchair and propulsion and exercise device including: a frame with at least two structural rails, pivoting front wheels, a rear set of laterally spaced wheels, and a surface for supporting the user; a drive support system attaching to the wheelchair frame and supporting a drive main frame; a propulsion system attached to the drive main frame and including an input unit operated by the user proximate the front end of the drive main frame; the propulsion system further including at least one drive wheel operably interposed between the rear set of wheelchair wheels and with a rotational axis positioned rigidly parallel to and below the wheelchair's rear wheel axis such that the drive wheel(s) supports a portion of the user's weight; and the propulsion system further including a power transmission assembly interposed between the input unit and the drive wheel to transmit torque when engaged by the user to propel the device.

The invention likewise comprises: a wheelchair device having a propulsion and exercise system attached and having a frame with at least two structural rails, pivoting front wheels, a rear set of laterally spaced wheels, and a surface for supporting the user. The device comprises: a drive support system attaching to the frame and supporting a drive main frame; a propulsion system attached to the drive main frame and including an input unit comprising a propulsion axleoperated by the user to generate power by rotating the propulsion axle; the propulsion system further including at least one drive wheel operably interposed between the rear set of wheelchair wheels and with a rotational axis positioned parallel to and below the wheelchair's rear wheel axis such that the drive wheel supports a portion of the user's weight; and the propulsion system further including a power transmission assembly interposed between the propulsion axleand the drive wheel to transmit power to the drive wheel when the propulsion axleis rotated by the user to propel the device.

### BRIEF DESCRIPTION OF THE DRAWINGS

FIG. 1 is a side perspective view of the Pedalong's first embodiment attached to a conventional wheelchair with the seat and back removed.

FIG. 2 is a close up perspective view of the rear axle of this first embodiment showing the chain sprocket, wheels, axle and attachment to the frame of the wheelchair.

FIG. 3 is a close-up top perspective view of the front drive assembly of the chain drive system in the first embodiment.

FIG. 4 is a top perspective of the second embodiment (belt-driven) as mounted on a wheelchair providing adjustability for user size and mobility; and, retraction of the pedal assembly under the wheelchair to ease user access.

FIG. 5 is a top perspective view showing the second embodiment removed from the wheelchair.

FIG. 6 is a top perspective view showing the second embodiment's drive parts with the supporting crossbars and front vertical guide removed.

FIG. 7 is a top perspective close-up view showing the second embodiment's rear axle assembly, and FIG. 8 shows the front axle assembly and pedals.

FIG. 8 is a top perspective close-up view showing details of the front axle.

FIG. 9 is a top view of FIG. 5.

FIG. 10 is a perspective cross-sectional view of FIG. 9 along line A-A, showing nesting of the three-section telescoping tubes from the left side, FIG. 10 also shows the drive belt, and the methodology of the idler pulleys' belt take-up which permits telescoping.

FIG. 11 is a perspective close-up view of the front vertical guide's clamping components.

FIG. 12 is a perspective view of the bottom of the second embodiment's mast showing the configuration of slots and pulleys.

FIG. 13 is contains a close-up perspective view of an attachment bracket and a portion of the wheelchair frame.

FIG. 14 is a top view of a schematic diagram of the shaft-driven sixth embodiment of the Pedalong System

FIG. 15 is a top view of the sixth embodiment drive components.

FIGS. 16 and 17 show close-up, cross-sectioned views of the sixth embodiment's pedal and drive wheel ends, respectively.

### DETAILED DESCRIPTION OF THE DRAWINGS

While this invention is susceptible of embodiment in many different forms, there is shown in the drawings, and will herein be described in detail, several specific embodiments, with the understanding that the present disclosure is to be considered merely an exemplification of the principles of the invention and the application is limited only to the appended claims.

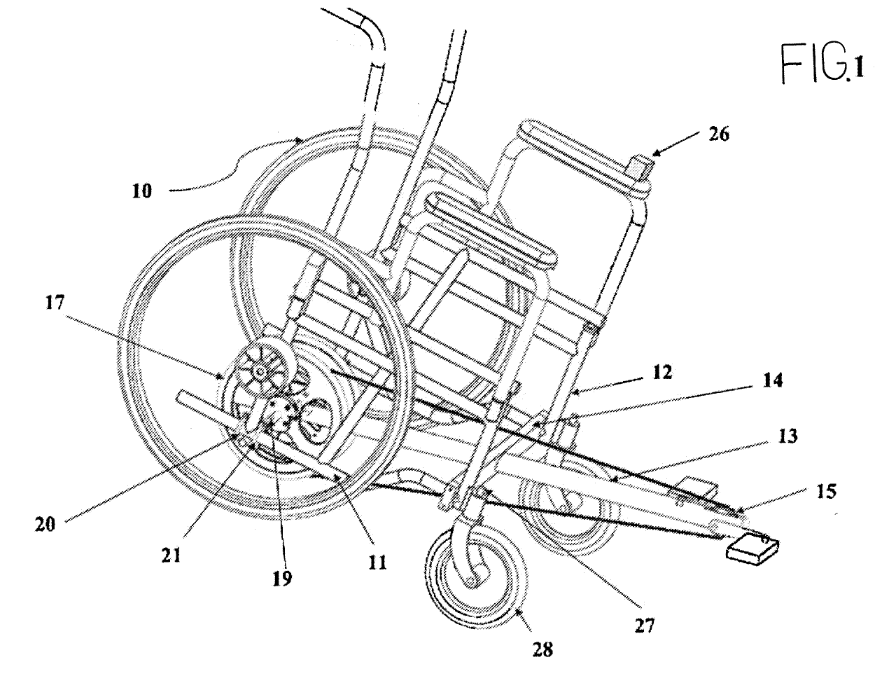

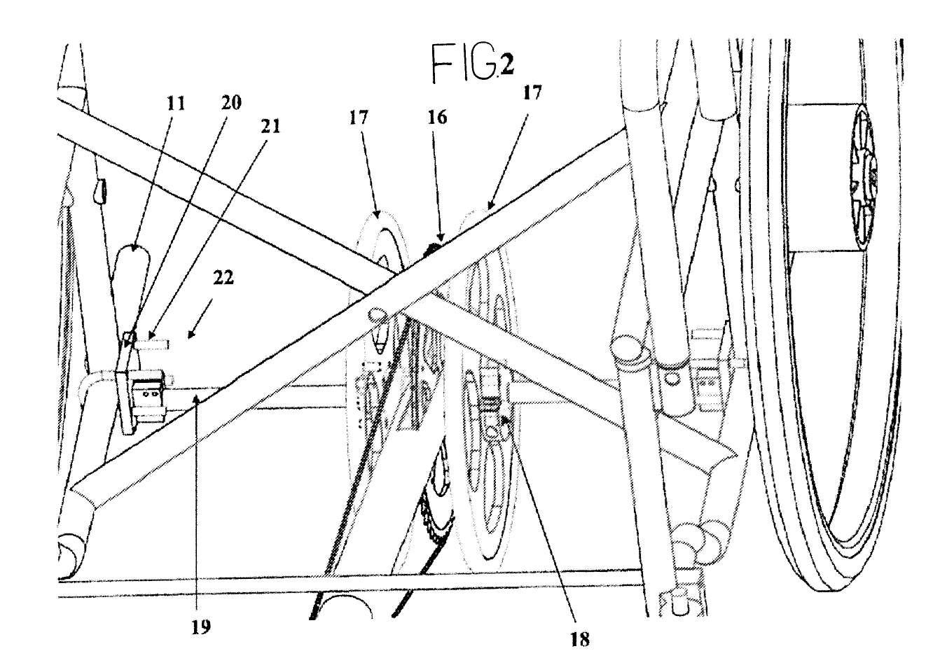

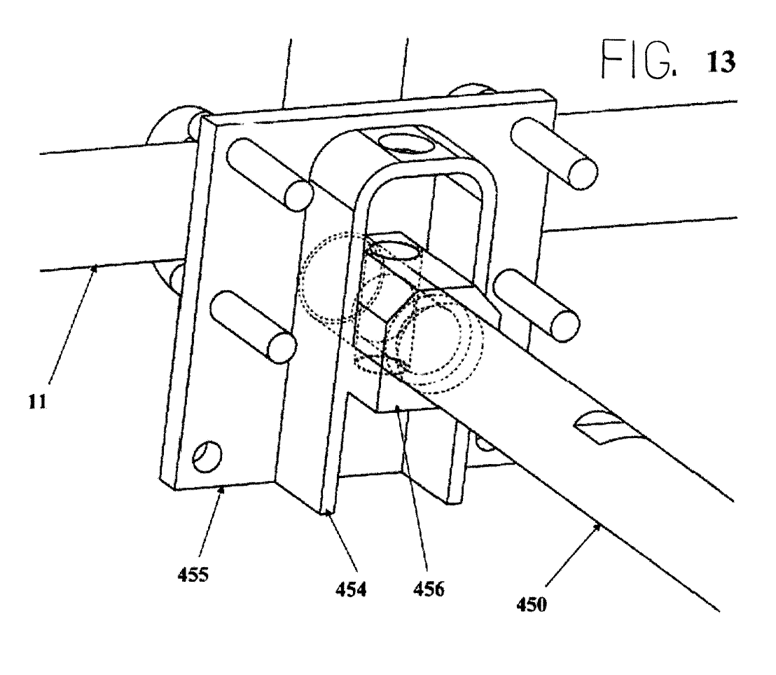

FIG. 1 shows a conventional wheelchair 10 with its structural rails 11 providing connection for its four wheels, and with the chain-driven first embodiment of the Pedalong 12 located between and supported between these rails. Front support frame 14 connects to the rails, and provides a rigid connection for the front end of the central tube 13. A drive chain connects the front sprocket 15 and (hidden) rear sprocket 16 (shown on FIG. 2). The rear wheels 17 and rear sprocket 16 (see FIG. 2) are interconnected through a rotating rear axle sleeve and clamp arrangement 18. This assembly is then supported by a cross-axle 19 which connects to the side rails 11 through an adjustable bracket 20 (so the fifth wheel will be appropriately positioned relative to the ground.) The U-bolts 21, placed in appropriate holes, and the vertical bolt drive (not shown) and the support nut 456 (see FIG. 13) provide coarse and fine adjustment, respectively.

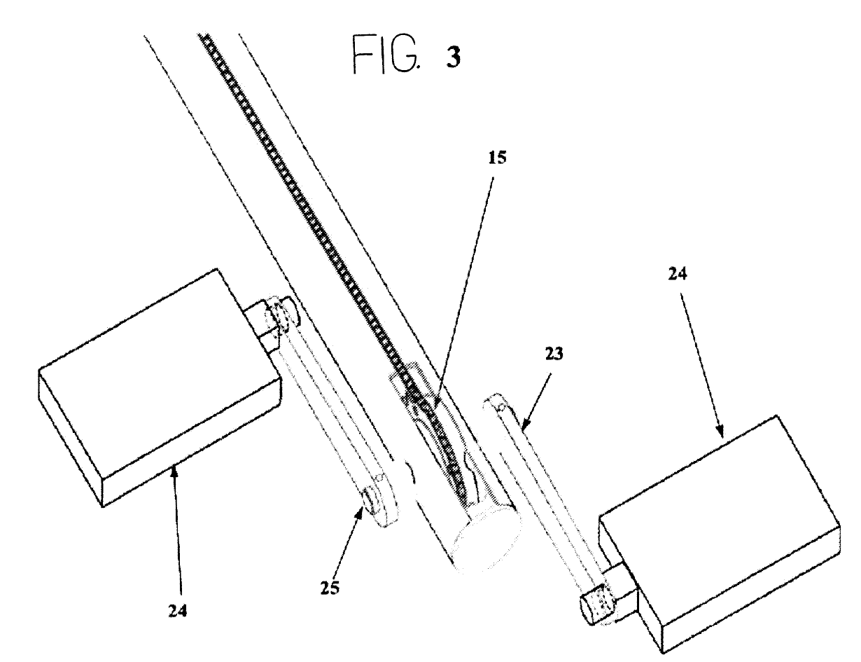

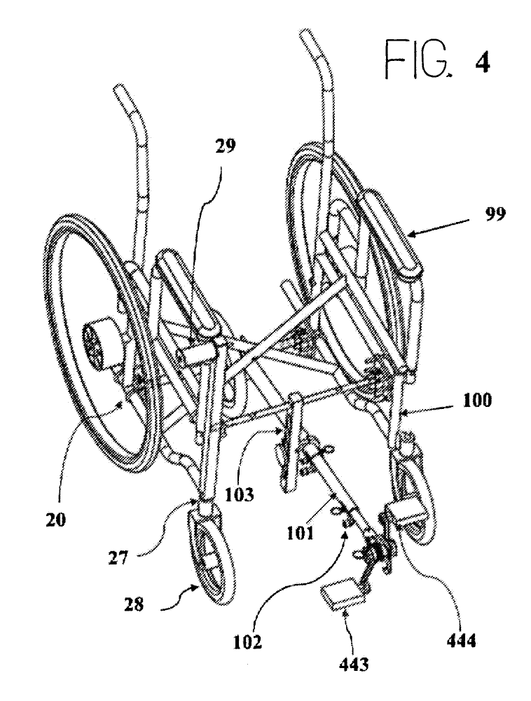

As shown on FIG. 3, the front drive assembly contains pedal arms 23, pedals 24, the front axle 25, and front sprocket 15. Odometer 26 is shown on FIG. 1 mounted on the left arm. If desired, a steering handle may be mounted on the right handle with a rod extending down and attaching to the top of the king pin 27 on the right front wheel 28 (like that shown on FIG. 4). For the first embodiment, the front frame 14 merely provides fixed support. By installing this frame in a lower or upper position, the installer can achieve a lower or higher pedal position. By cutting off a portion of the main support 13 and changing the chain length, the installer can (with effort) adjust the pedal position to fit a shorter user. Embodiment two reduces the amount of effort needed to do so with its telescoping mast, and adjustable front support. The figures and specification show a three-tube mast, but a two-tube mast will suffice for shorter patients.

FIG. 4 shows a wheelchair 99 with the second embodiment of Pedalong 100 mounted to its frame. In the (belt-driven) second embodiment, the length of the mast 101 is telescopically adjustable and four idler sprockets 102 take up the excess belt length when the mast 101 telescopes. Further, the front vertical support 103 of this second embodiment is easily adjusted for height. Combining the adjustable front support and telescoping features permits the pedal position to be adjusted completely for fit to users of various sizes. FIG. 4 also shows the steering handle 29 mounted to control the angle of right front wheel 28.

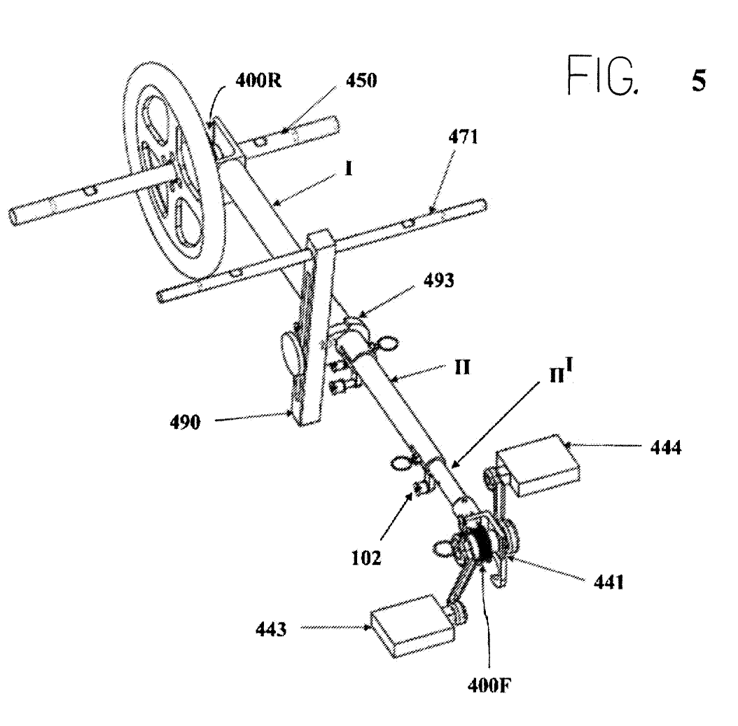

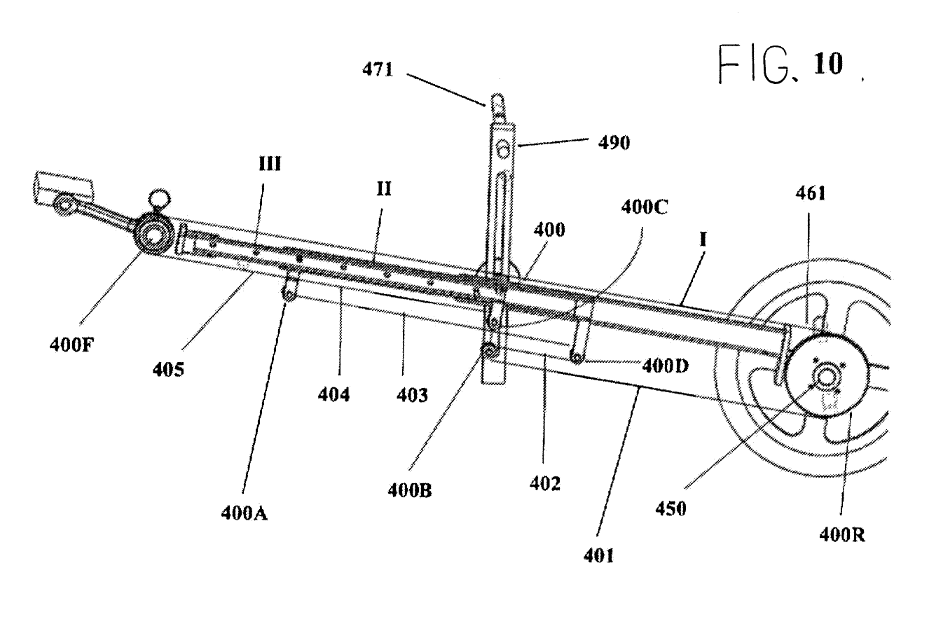

FIG. 5 shows the second embodiment without the wheelchair and attachment brackets. The three telescoping elements (I, II and III, collectively termed the “mast”) extend forward from the rear axle 450 to the pedal axle 449, and carry the front pulley 400F. A belt 400 to 405 (not shown here, but on FIG. 10) transfers the pedal axle rotation of the front pulley 400F to the rear pulley 400R along top strand 400. The belt's lower strand is serpentinely looped around a set of four pulleys to provide length adjustability. All belt strands are parallel to the telescoping system's axis and all pulleys are below the mast (as shown on FIG. 10.) only the length changing strands actually need to be parallel for the belt to stay tight during mast length change adjustment. On the lower (untensioned) strands 401 to 405 the pulleys 400A, 400B, 400C, and 400D serve as take up rollers to provide a means for keeping the belt at constant length when the system is retracted.

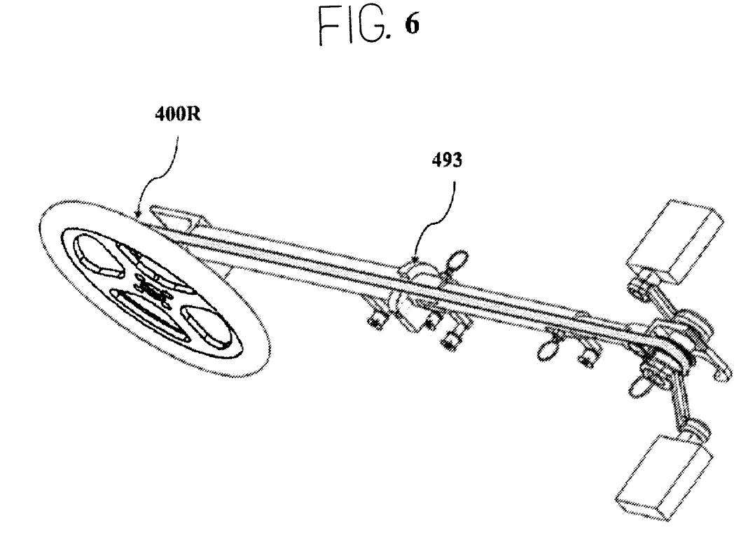

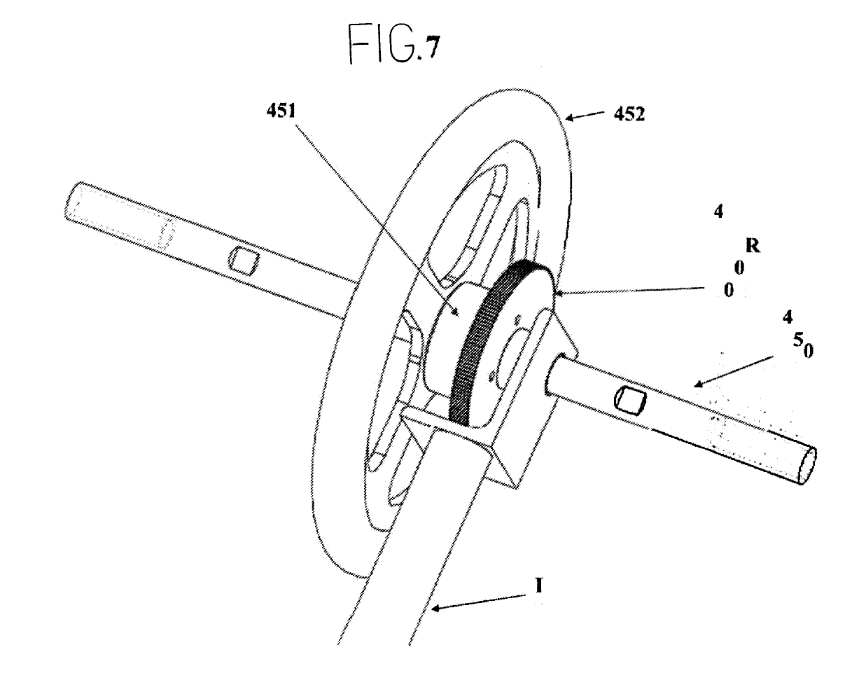

FIG. 6 shows the second embodiment with the rear axle and front supports removed. The opening in the ring 493 for the clamping screw 492 is clearly visible. FIG. 7 shows the rear axle drive components which are supported on the rear axle 450. A sleeve or hub 451 connects the rear pulley 400R to the drive wheel 452, and this assembly rotates on the fixed rear axle 450.

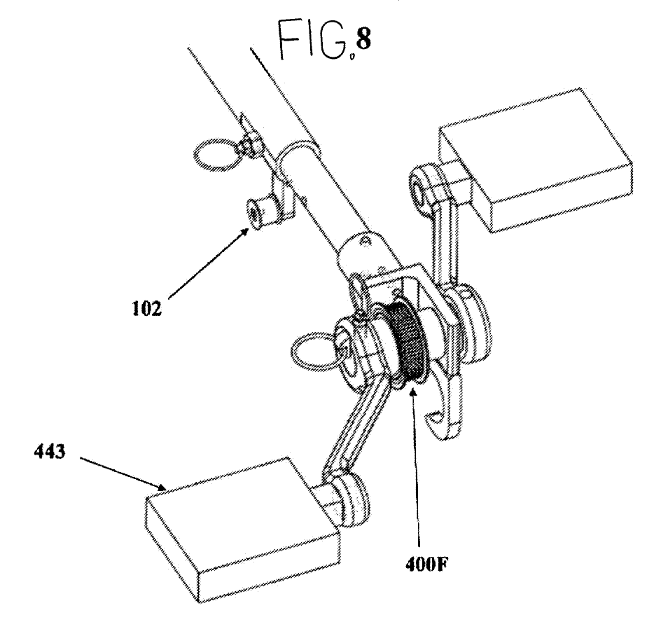

FIG. 8 shows details of the front axle. The front pulley 400F is keyed to the front shaft by key 448. When detent 449 is lifted, key 448 can be pulled outward disengaging pulley 400F from the shaft. This is ordinarily done by the therapist when the Pedalong is retracted under the wheelchair to prevent rotation of the pedals when the wheelchair is pushed manually. The front assembly shown in FIG. 8 slides over the end of inner tube III, and is locked to it by a retaining screw 466. A second screw 467 pushes the front assembly away from inner tube III to tension the belt after it is installed, and before retaining screw 466 locks the position.

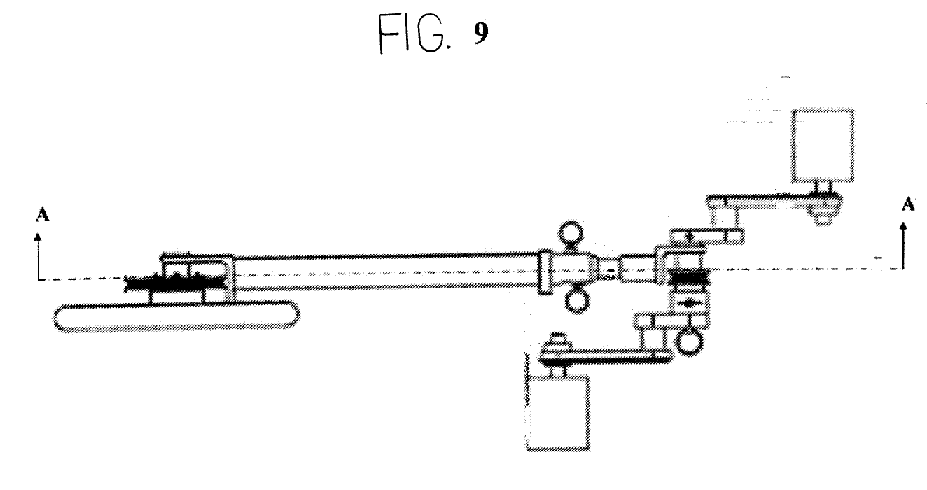

As shown in FIG. 9, tube I is supported rotatably from rear axle 450 by bearing 462 which is mounted in flanged end 461 of tube I. Also rotatably mounted on rear axle 450 is the rear axle assembly which includes the rear pulley 400R, the hub 451, the rear wheel 452, and, optionally, a spur gear (not shown) for accepting power from an electric motor (not shown) which may also be supported from the rear axle.

FIG. 10 shows the belt take-up mechanism. When tubes I and II are held fixed, and tube III is moved to the right, top strand 400 shortens and strand 404 lengthens by equal amounts while all other strand lengths are unchanged. (Pulley 400C which extends through both slot 470 in tube II and slot 472 in tube I, moves to the right with tube III covering the lengthening of strand 404). Thus, the drive belt remains tight when the mast length is adjusted.

Pulleys 400A and 400D are mounted on tube II with pulley 400D extending through the slot 472 in tube I. As shown on FIG. 10, when tubes II and III are moved to the right together, top strand 400 shortens and strand 402 lengthens by equal amounts while other strand lengths are unchanged. Again, the belt remains tight.

If front pulley 400F and rod III are fixed, but tube II is moved to the right, strand 404 shortens while strand 402 lengthens also preserving belt tightness.

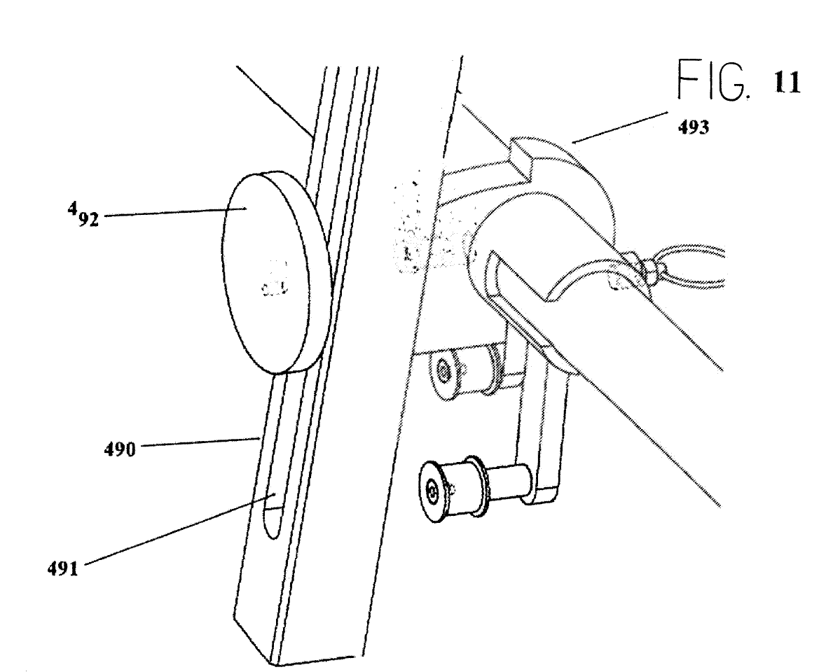

In FIG. 11, vertical guide 490 includes a slot 491 through which adjusting and clamping screw 492 passes. The screw there engages support ring 493. In adjusting the Pedalong height, the therapist loosens clamping screw 492 and the entire mast system is then rotated around the drive wheel axis using finger grip 653.

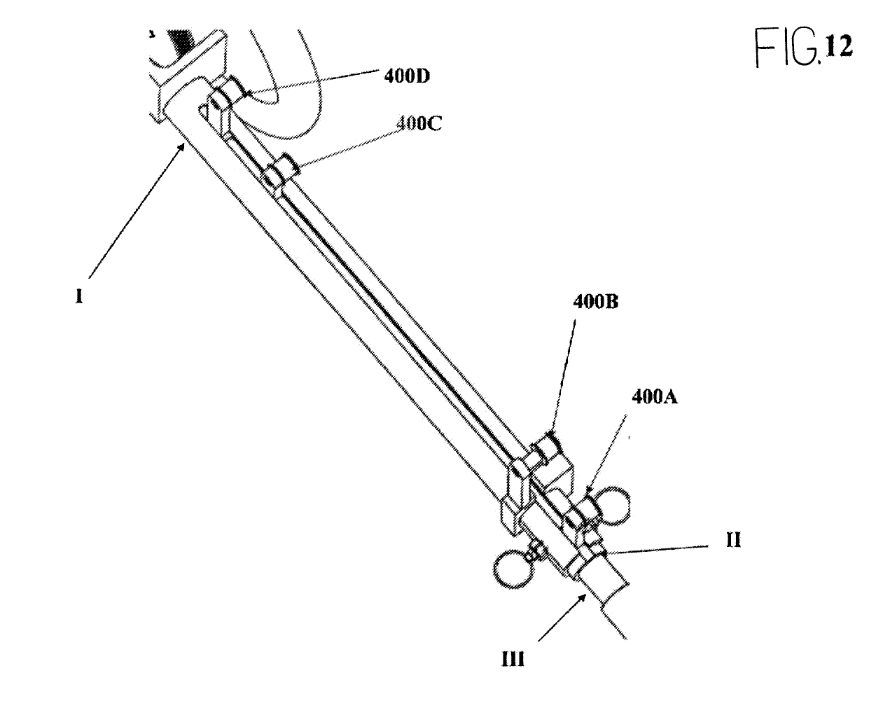

FIG. 12 shows the pulleys 400A, 400B, 400C, and 400D, and their slot positions. This figure clearly shows from which mast segment each pulley is supported, and how pulley 400C is mounted so as to slide past pulley 400B. Pulleys 400A and 400D are both mounted on tube II and move with it. Pulley 400C and front pulley 400F (omitted from FIG. 12) both move with tube III. Pulleys 400B and 400R on tube I are also separated by a fixed distance.

In adjusting embodiment two, the therapist extends tube III and tube II together, while right-hand detent 654 (See FIG. 9) is lifted by the thickness of tube II, by pulling on finger grip 653 to the desired extension with the left hand. Then, detent 654 is released. Next, left-hand detent 656 is lifted and rod III is pulled to the desired final length. The vertical adjustment of the pedals is accomplished with the front support 103.

FIG. 13 shows the adjustable attachment bracket which supports both ends of cross-axle 450. These attachment brackets connect to the side rails 11 through U-bolts 21 placed in appropriate holes. The support nut 456 provides fine adjustment of axle height so the fifth wheel will be appropriately positioned relative to the ground. The support nut is driven up and down in channel 454 by a bolt (not shown) which is secured to channel 454 by an interior shoulder and wingnut at the top end after the head (which extends below) is rotated to position the nut. (The same attachment brackets are used on the front support.)

The third embodiment (not illustrated) of the belt-driven Pedalong differs from embodiment two by replacement of the front-operated, detent-based extension/retraction method of embodiment two with a side-lever and extension linkage. The second embodiment may be cheaper and more convenient for a therapist, who must be in front of the patient to assist in seating, adjusting pedal location, and in placing the patient's feet in the pedal straps.

The third embodiment empowers the user who can control the drive systems position and provide its adjustment. For this third embodiment, the rear axle assembly, telescoping tubes, and pulleys and belt, are the same as in embodiment two. The finger grip 653 on the front, used for extension/retraction in embodiment two, is eliminated. Also, the detents necessary for locking the tubes in an extended position in embodiment two are replaced by a detent on the side lever. This third embodiment uses a simple slider-crank mechanism to extend the mast when the cross-bar at the front is rotated by the side-operated lever. In the third embodiment the adjustable front support rotates freely on the crossbar which rotates the crank arm of the mechanism.

Embodiment four (not illustrated) is simply the addition of the electric motor, battery, and control system mentioned above to drive the Pedalong or augment the pedaling. The motor can conveniently be hung from the rear axle and transfer its power to the rear axle assembly through a spur gear on an extension of hub 451 across the wheel 452. This method of mounting is used in locomotive traction motor installation.

Embodiment five (not shown) provides for powering the telescoping movement by a battery-driven electric motor rotating a power screw which runs inside the tubular main frame to a nut located at the rear of its forward section. This embodiment empowers the user by placing control of pedal position with the user. It may be combined with a removable (or foldable) side frame at the seat so the user can move to and from the wheelchair without aid.

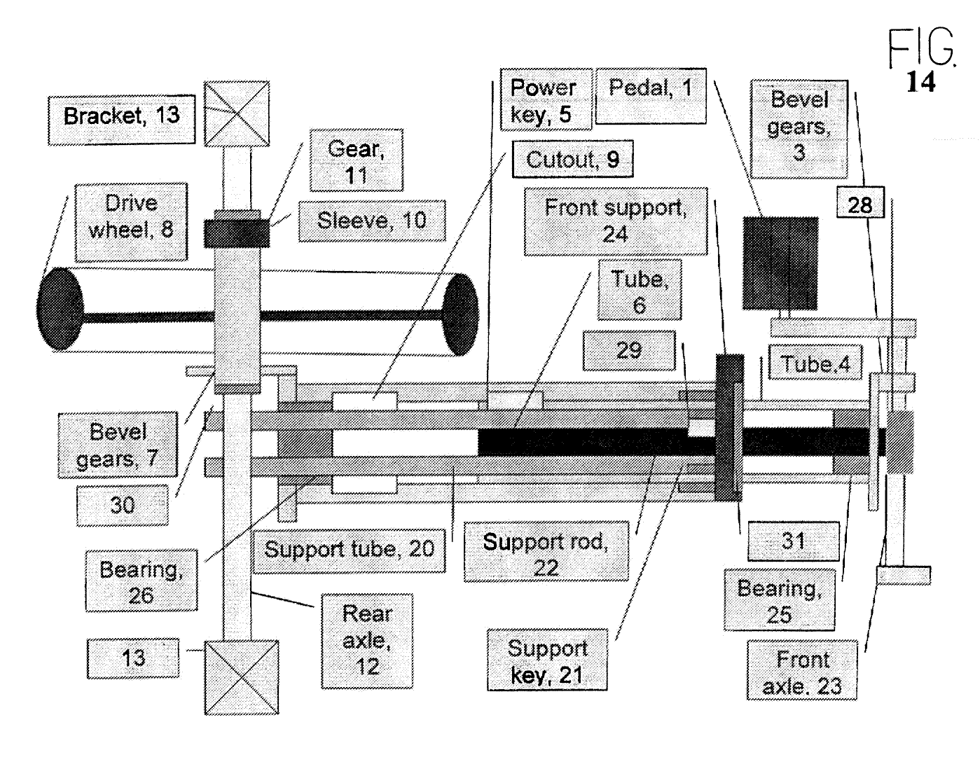

FIG. 14 is a schematic and sectioned view from above of the shaft-driven sixth embodiment of the Pedalong with conventional pedals extending forward (to the right in this view) of the seat, and the drive wheel 8 located midway between the wheelchair's large rear wheels (not shown). The system is shown partially extended from its retracted position as appropriate for a child.

The sixth embodiment of Pedalong (shaft-driven rather than belt-driven) transfers the pedal power from pedals 1 to the rear drive wheel 8 through bevel gear pairs 3 and 7, and the telescoping shaft comprised of tubes 4 and 6. The power key 5 locks tubes 4 and 6 together rotationally while still permitting axial sliding of front tube 4 rearward within rear tube 6 until the key 5 enters cutout 9 where it releases the rotational lock.

Sleeve 10 rotates on fixed axle 12 which is supported by brackets 13 which attach to the framing of the wheelchair (not shown). The sleeve 10 carries and rotates with the rear bevel gear 7 and the drive wheel 8, and provides a connection gear 11 for an optional power system (not shown) to drive the wheelchair.

A rear support tube 20 and front support rod 22 connect the rear axle 12 to the front (pedal) axle 23. Key 21 prevents rotation between the support tube 20 and rod 22. Front support 24 provides control of vertical position of all these tubes relative to the wheelchair frame. The front or pedal axle 23 rotates about its axis when the pedals 1 are pressed, the power tubes rotate, and the sleeve 10 and rear wheel 8 rotate driving the wheelchair forward or back.

To reduce friction and wear, bearings are provided as follows: 25 carries the front drive tube 4 on the support rod 22; 26 carries the rear drive tube 6 on the support tube 20; 28 carries the pedal shaft 23 on the support rod; 29 carries the front drive tube on the support tube 20; 30 carries the wheel sleeve 10 on the rear axle 12; and, 31 carries drive tubes 6 in the front support 24. A variety of front support systems may be employed. These may provide vertical position only (when connected at the rear drive tube), or may simultaneously lift and extend the front drive tube and pedals forward when connected to the front drive tube (like the third embodiment of the belt-driven, side-operated embodiment described above).

The pedal shaft can also incorporate a pump and the drive wheel assembly can incorporate a hydraulic motor. These two units are connected by tubing. Similarly, the pedal shaft may rotate a generator and the drive assembly, an electric motor with wiring between the two. Of course, extra resistance to pedaling can be added to improve exercise quality or power can be added to aid propulsion.

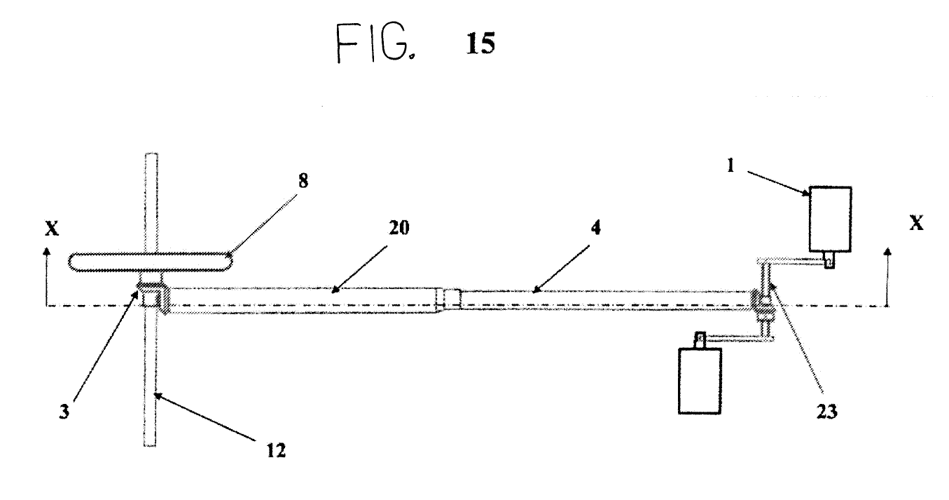

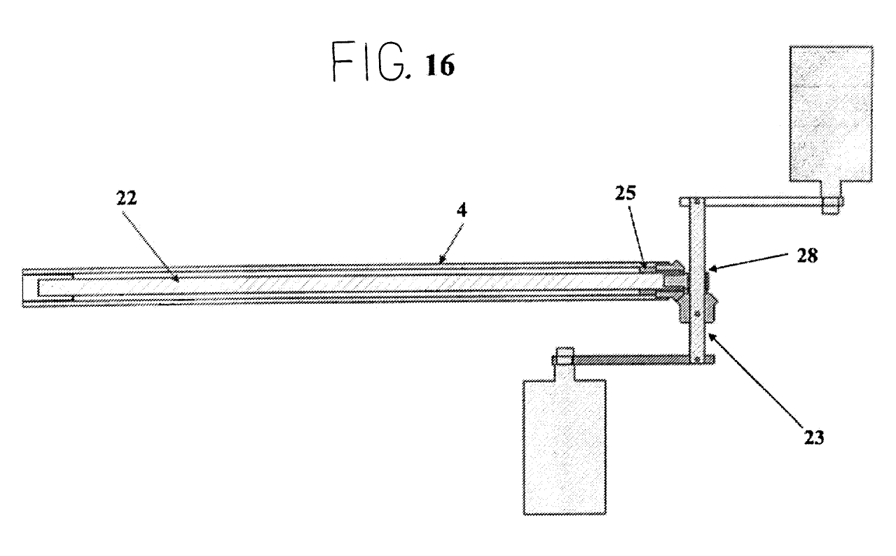

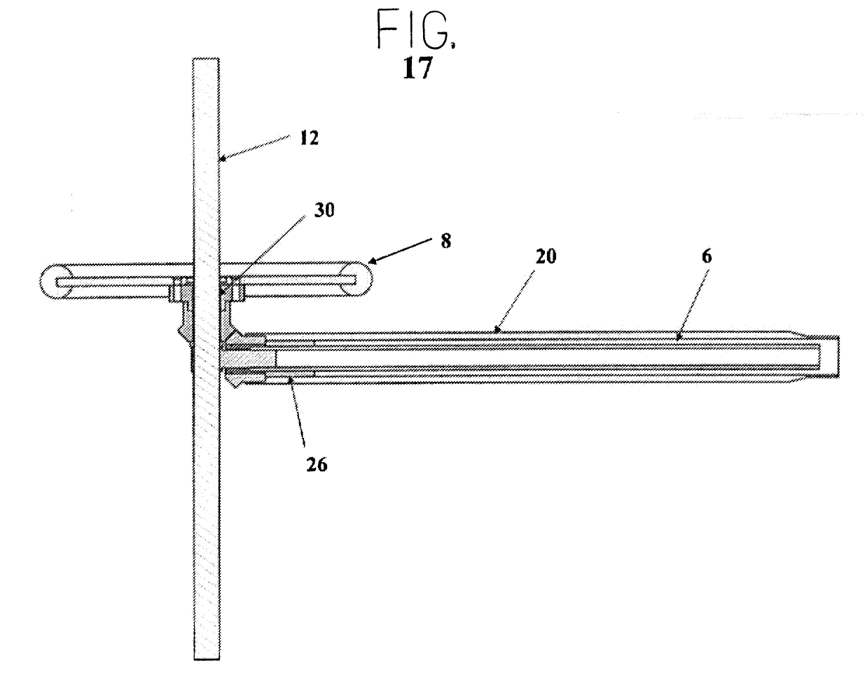

FIGS. 15, 16 and 17 show a physical design for embodiment six. Bevel gears are expensive and require tight tolerances for their proper operation.

The Pedalong's fifth wheel and a forward support provide a method for weighing the wheelchair occupant using a conventional scale.

It will be understood that modifications and variations may be effected without departing from the scope of the novel concepts of the present invention, but it is understood that this application is limited only by the scope of the appended claims.

What is claimed is:

1. A propulsion and exercise device attaching to a conventional wheelchair having a frame with at least two structural rails, pivoting front wheels, a rear set of laterally spaced wheels, and a surface for supporting the user, the device comprising:
A drive support system attaching to the wheelchair frame and supporting a drive main frame;
a propulsion system attached to the drive main frame and including an input unit operated by the user proximate the front end of the drive main frame;
the propulsion system further including at least one drive wheel operably interposed between the rear set of wheelchair wheels and with a rotational axis positioned parallel to and below the wheelchair's rear wheel axis such that the drive wheel(s) supports a portion of the user's weight; and
the propulsion system further including a power transmission assembly interposed between the input unit and the drive wheel to transmit power from said input unit to the drive wheel when engaged by the user to propel the device.

2. The device of claim 1 wherein the propulsion system is belt driven.

3. The device of claim 1 wherein the propulsion system is chain driven.

4. The device of claim 1 wherein the propulsion system is shaft driven.

5. The device of claim 1 wherein the propulsion system is fluid power driven.

6. The device of claim 1 wherein the propulsion system is electrically driven.

7. The device of claim 1 wherein the input unit is mounted at a forward end of the main frame, so as to be adjustable in length.

8. The device of claim 1 wherein the input unit comprises:
a front power transfer link rotatably mounted on a shaft; and,
at least one pedal operably mounted on said shaft to permit the user's rotation of said power transfer link,
and wherein the power transmission assembly is operably engaged with the power transfer link at one end and the drive wheel at the opposite end and wherein the drive wheel is fixedly mounted on a common shaft with drive wheel linkage.

9. The device of claim 8 wherein said power transfer link is a pulley-belt-pulley assembly.

10. The device of claim 9 wherein said power transfer link is a gear-shaft-gear assembly.

11. The device of claim 8 wherein said power transfer link comprises:
a hydraulic pump;
tubing operably connected to said pump; and,
a hydraulic motor operably associated with said tubing.

12. The device of claim 8 wherein said power transfer link comprises:
an electrical generator;
wiring operably connected to said generator; and,
an electric motor operably associated with said wiring.

13. The device of claim 1 wherein the drive main frame is supported by the drive support system such that the drive main frame can rotate about an axis parallel to the axis of the drive wheel to provide height adjustability of the input unit and facilitate access to the user support surface by lowering.

14. The device of claim 8 wherein the drive main frame length is adjustable for user size and to further facilitate access to said user support surface.

15. The device of claim 14 wherein the drive main frame length adjustability is provided by telescoping tubes or other prismatic structure, and the transmission assembly automatically compensates for the length change through adjustment means.

16. The device of claim 15 wherein the adjustment means comprises idler sprockets.

17. The device of claim 15 wherein the adjustment means comprises pulleys.

18. The device of claim 15 wherein the adjustment means comprises splines.

19. The device of claim 15 wherein the height and/or length adjustments are electrically driven.

20. The device of claim 15 wherein electrical power is provided to the propulsion system to at least assist in driving the wheelchair.

21. The device of claim 1 also including an odometer for recording the distance traveled.

22. The device of claim 1 also including a brake for slowing, stopping or parking the wheelchair.

23. The device of claim 1 also including a “deadman switch” that releases the propulsion system to allow motion only when activated by the user.

24. The device of claim 1 providing a method for weighing the wheelchair occupant using a conventional scale.

25. A method for converting a conventional wheelchair having a frame with at least two structural rails, pivoting front wheels, a rear set of laterally spaced wheels and a surface for supporting the use, to a propulsion and exercise device comprising:
Operably attaching a drive support system to the frame and supporting a drive main frame;
Operably attaching a propulsion system attached to the drive main frame and including an input unit operated by the user proximate the front end of the drive main frame;
operably interposing at least one drive wheel between the rear set of wheelchair wheels with a rotational axis parallel to and below the wheelchair rear wheel axis; and
operably including a power transmission assembly interposed between the input unit and the drive wheel to transmit torque when engaged by the user to propel the device.

26. A combination wheelchair and propulsion and exercise device comprising:
a frame with at least two structural rails, pivoting front wheels, a rear set of laterally spaced wheels, and a surface for supporting the user;
a drive support system attaching to the wheelchair frame and supporting a drive main frame;
a propulsion system attached to the drive main frame and including an input unit operated by the user proximate the front end of the drive main frame;
the propulsion system further including at least one drive wheel operably interposed between the rear set of wheelchair wheels and with a rotational axis positioned rigidly parallel to and below the wheelchair's rear wheel axis such that the drive wheel(s) supports a portion of the user's weight; and
the propulsion system further including a power transmission assembly interposed between the input unit and the drive wheel to transmit torque when engaged by the user to propel the device.

27. A wheelchair device having a propulsion and exercise system attached and having a frame with at least two structural rails, pivoting front wheels, a rear set of laterally spaced wheels, and a surface for supporting the user, the device comprising:
A drive support system attaching to the frame and supporting a drive main frame;
a propulsion system attached to the drive main frame and including an input unit comprising a propulsion wheel operated by the user to generate power by rotating the propulsion wheel;
the propulsion system further including at least one drive wheel operably interposed between the rear set of wheelchair wheels and with a rotational axis positioned parallel to and below the wheelchair's rear wheel axis such that the drive wheel supports a portion of the user's weight; and
the propulsion system further including a power transmission assembly interposed between the propulsion wheel and the drive wheel to transmit power to the drive wheel when the propulsion wheel is rotated by the user to propel the device.
